(19) United States
(12) Patent Application Publication
(10) Pub. No.: US 2015/0373483 A1
(43) Pub. Date: Dec. 24, 2015

(54) METHODS, APPARATUS, AND COMPUTER-READABLE MEDIUM FOR PROVIDING ALTERNATE VISUALIZATION VIA WIRELESS DOCKING

(71) Applicant: QUALCOMM Incorporated, San Diego, CA (US)

(72) Inventors: Lochan Verma, San Diego, CA (US); Vijayalakshmi Rajasundaram Raveendran, San Diego, CA (US); Jonathan Karl Kies, Encinitas, CA (US); Daniel James Guest, San Diego, CA (US); Hongyu Jiang, San Diego, CA (US)

(21) Appl. No.: 14/579,059

(22) Filed: Dec. 22, 2014

Related U.S. Application Data
(60) Provisional application No. 62/015,915, filed on Jun. 23, 2014.

(51) Int. Cl. H04W 4/00; G06F 13/40; H04W 76/02

(52) U.S. Cl. CPC H04W 4/008; H04W 76/02; G06F 13/4068

(57) ABSTRACT

Various aspects of the present disclosure provide for a first device that may establish a wireless docking session with a second device. The first device may determine whether a profile of a second device matches a profile stored in the first device. When such a match exists, the first device may export data to the second device in a format associated with the profile of the second device. When such a match does not exist, the first device may provide an error message or export data to the second device in a format associated with a default profile of the first device. The profile may indicate an operating system, a peripheral component, a display size, a display resolution, a touch screen-capability, a font type, a user setting, a power source or availability, a hardware component, or a software module. Additional aspects, embodiments, and features are also provided herein.

### CROSS-REFERENCE TO RELATED APPLICATION(S)

This application claims priority to and the benefit of provisional patent application No. 62/015,915, filed in the United States Patent and Trademark Office on Jun. 23, 2014, the entire content of which is incorporated herein by reference as if fully set forth below and for all applicable purposes.

### TECHNICAL FIELD

Aspects of the present disclosure relate, generally, to wireless docking and, more particularly, to providing alternate visualization on a device via wireless docking.

### BACKGROUND

Wireless communication systems can provide wireless communication between multiple devices. Devices may wirelessly connect to each other using various technologies. Once connected, a first device (e.g., a smartphone) may transmit (e.g., ‘push’) data for display on a second device (e.g., a desktop computer). Existing systems may merely replicate the user experience of the first device (e.g., an Android™ operating system-based user experience) on the second device (e.g., the desktop computer), even if the second device (e.g., the desktop computer) customarily provides a different user experience (e.g., a Windows™ operating system-based user experience).

However, merely replicating the visualization of the first device (e.g., an Android™ operating system-based user experience) on the second device (e.g., the desktop computer) may be undesirable for the user. Instead, the user may prefer the user experience to which they are accustomed for the second device (e.g., a Windows™ operating system-based user experience on their desktop computer). Accordingly, enhancements associated with providing an alternate visualization may improve the user experience.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure provide for a first device that establishes a wireless docking session with a second device. The first device may determine whether a profile of the second device matches a profile stored in the first device. When such a match exists, the first device may export data to the second device in a format associated with the profile of the second device. When such a match does not exist, the first device may provide an error message or export data to the second device in a format associated with a profile of the first device. The profile may indicate an operating system, a peripheral component, a display size, a display resolution, a touch screen-capability, a font type, a user setting, a power source or availability, a hardware component, or a software module. Additional aspects, embodiments, and features are also provided herein.

In one aspect, the disclosure provides a method that includes establishing a wireless docking session with a second device, determining whether a profile of the second device matches one of a plurality of profiles stored in the first device, and exporting data to the second device in a format associated with the profile of the second device when the profile of the second device matches one of the plurality of profiles stored in the first device.

In another aspect, the disclosure provides an apparatus including a transceiver, a memory, and at least one processor communicatively coupled to the transceiver and the memory. The at least one processor may be configured to establish a wireless docking session with a device, determine whether a profile of the device matches one of a plurality of profiles stored in the apparatus, and export data to the device in a format associated with the profile of the device when the profile of the device matches one of the plurality of profiles stored in the apparatus.

In another aspect, the disclosure provides another apparatus including means for establishing a wireless docking session with a device, means for determining whether a profile of the device matches one of a plurality of profiles stored in the apparatus, and means for exporting data to the device in a format associated with the profile of the device when the profile of the device matches one of the plurality of profiles stored in the apparatus.

In another aspect, the disclosure provides a computer-readable storage medium including code for establishing a wireless docking session with a second device, determining whether a profile of the second device matches one of a plurality of profiles stored in the first device, and exporting data to the second device in a format associated with the profile of the second device when the profile of the second device matches one of the plurality of profiles stored in the first device.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a hardware implementation of a master device.

FIGS. 2-4 are diagrams illustrating examples of user interfaces of various profiles of the master device.

FIGS. 5-7 are diagrams illustrating examples of user interfaces of various profiles of a slave device.

FIGS. 8-9 are diagrams illustrating examples of various profiles of the master device and the slave device.

FIGS. 10-11 are diagrams illustrating examples of proximities of the slave device relative to the master device.

FIG. 12 is a diagram illustrating an example of various items displayed on the master device and the slave device.

FIG. 13-14 are diagrams illustrating examples of various methods and/or processes.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

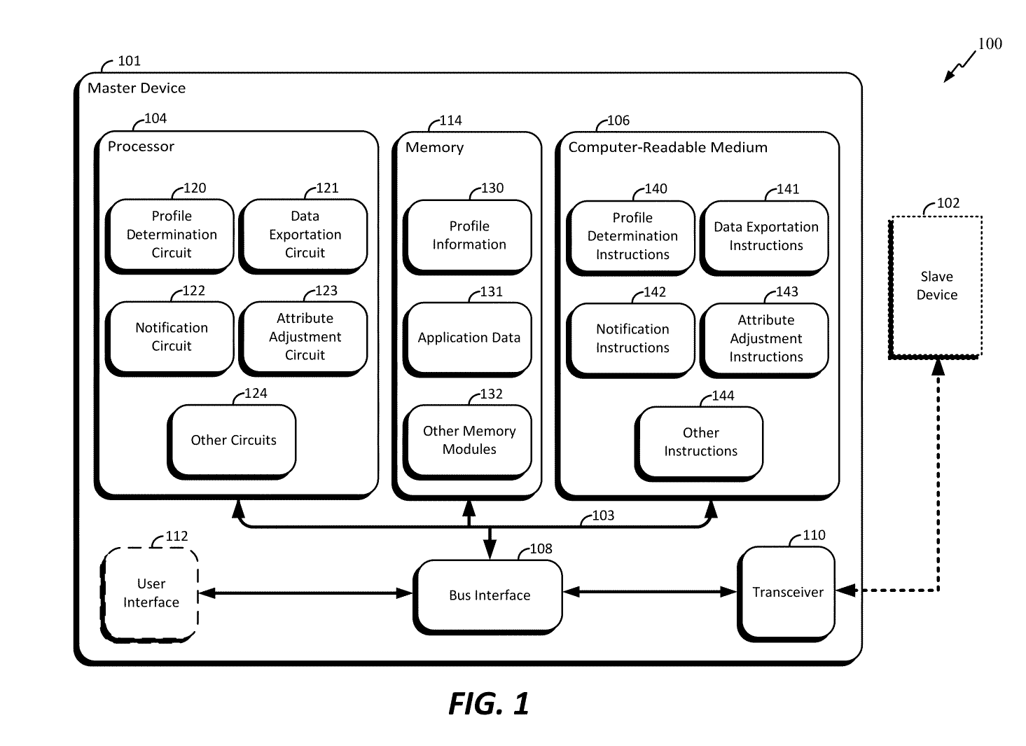

FIG. 1 is a diagram 100 illustrating an example of a hardware implementation of the master device 101 in accordance with various aspects of the present disclosure. Although various portions of the description provided herein may refer to the “master device 101,” one of ordinary skill in the art will understand that the “master device 101” may be any apparatus configured to communicate with another apparatus. By way of example and not limitation, the master device 101 may be a cellular telephone, a smartphone, user equipment, a tablet computer, a laptop computer, a personal digital assistant (PDA), a gaming device, an e-reader, and/or any other apparatus configured to communicate with another apparatus.

The master device 101 may include a user interface 112. The user interface 112 may be configured to receive one or more inputs from a user of the master device 101. The user interface 112 may also be configured to display information (e.g., text and/or images) to the user of the master device 101. The user interface 112 may exchange data to and/or from the processing system 101 via the bus interface 108.

The master device 101 may also include a transceiver 110. The transceiver 110 may be configured to receive data and/or transmit data in communication with another apparatus. The transceiver 110 provides a means for communicating with another apparatus via a wired or wireless transmission medium. For example, the transceiver 110 may provide the means for establishing a wireless docking session with another apparatus and/or device, such as the slave device 102. The transceiver 110 may be configured to perform such communications using various types of technologies. One of ordinary skill in the art will understand that many types of technologies to perform such communication may be used without deviating from the scope of the present disclosure.

The master device 101 may also include a memory 114, one or more processors 104, a computer-readable medium 106, and a bus interface 108. The bus interface 108 may provide an interface between a bus 103 and the transceiver 110. The memory 114, the one or more processors 104, the computer-readable medium 106, and the bus interface 108 may be connected together via the bus 103.

The processor 104 may be communicatively coupled to the transceiver 110 and/or the memory 114. The processor 104 may include a profile determination circuit 120. The profile determination circuit 120 may include various hardware components and/or software modules that can perform various functions and/or enable various aspects associated with the profile of the master device 101. The profile of the master device 101 may refer to the set of parameters and/or functions that characterize the operability and/or user experience of the master device 101. The profile of the master device 101 may include information related to the operating system of the master device 101, one or more peripheral components of the master device 101, a display size of one or more displays of the master device 101, a display resolution of one or more displays of the master device 101, a touch screen-capability of the master device 101, one or more font types of the master device 101, one or more user settings of the master device 101, an extended display identification data (EDID) of the master device 101, the power source/availability of the master device 101, one or more hardware components of the master device 101, and/or one or more software modules of the master device 101. Additional description pertaining to the profile of the master device 101 is provided throughout this disclosure. The profile determination circuit 120 provides the means for determining whether a profile of another device (e.g., the slave device 102) matches one of a plurality of profiles stored in the master device 101.

The processor 104 may also include a data exportation circuit 121. The data exportation circuit 121 may include various hardware components and/or software modules that can perform various functions and/or enable various aspects associated with exporting data from the master device 101. For example, the data may be exported to another device (e.g., the slave device 102). In some circumstances, the profile of the slave device 102 matches one of the plurality of profiles stored in the master device 101. In such circumstances, the data exportation circuit 121 provides the means for exporting data to the slave device 102 in a format associated with the profile of the slave device 102. However, in some other circumstances, the profile of the slave device 102 does not match one of the plurality of profiles stored in the master device 101. In such circumstances, the data exportation circuit 121 provides the means for exporting data to the slave device 102 in a format associated with a default profile of the master device 101.

The processor 104 may also include a notification circuit 122. The notification circuit 122 may include various hardware components and/or software modules that can perform various functions and/or enable various aspects associated with providing notifications to the master device 101 and/or the slave device 102. When the profile of the slave device 102 does not match one of the plurality of profiles stored in the master device 101, the notification circuit 122 provides the means for providing an error message on the master device 101 and/or the slave device 102. For example, the error message may indicate that none of the profiles stored in the master device 101 matches any of the profiles of the slave device 102.

In some circumstances, the slave device 102 is within a proximity range of the master device 101. The proximity range may be a particular distance relative to the location of the master device 101. In such circumstances, the notification circuit 122 provides the means for providing a notification for display on the slave device 102. For example, such notifications may include various alerts, such as low-battery′ alerts. Because the slave device 102 is within the proximity range of the master device 101, notifications displayed on the slave device 102 are more likely to be viewed by the user.

In some other circumstances, the slave device 102 is beyond the proximity range of the master device 101. For example, the master device 101 (e.g., a smartphone) may be moved by the user out of a room having the slave device 102 (e.g., a desktop computer). When the slave device 102 is beyond the proximity range of the master device 101, the notification circuit 122 provides the means for providing various notifications (e.g., alerts, such as ‘low-battery’ alerts) for display on the master device 101. Because the user (together with the master device 101) has moved beyond the proximity range of the master device 101, notifications displayed on the slave device 102 are less likely to be viewed by the user, and notifications displayed on the master device 101 are more likely to be viewed by the user.

The processor 104 may also include an attribute adjustment circuit 123. The attribute adjustment circuit 123 may include various hardware components and/or software modules that can perform various functions and/or enable various aspects associated with adjusting an attribute of the data for export to the slave device 102. In some configurations, the attributes of the data may be adjusted based on bandwidth availability. Accordingly, the attributes adjustment circuit 123 provides the means for adjusting the attribute of the data for export to the slave device 102 based on bandwidth availability. Attributes that may be adjusted include a file size, a refresh rate, a display resolution, a bit rate, a quality parameter, and/or a domain. Such attributes may be adjusted such that the exported data occupies relatively less bandwidth when bandwidth availability is relatively low. Conversely, such attributes may be adjusted such that the exported data occupies relatively more bandwidth when bandwidth availability is relatively high.

The foregoing description provides a non-limiting example of the processor 104 of the master device 101. Although various circuits have been described above, one of ordinary skill in the art will understand that the processor 104 may also include various other circuits 124 that are in addition and/or alternative(s) to circuits 120, 121, 122, 123. Such other circuits 124 may provide the means for performing any one or more of the functions, methods, processes, features and/or aspects described herein.

The computer-readable medium 106 may include various instructions. The instructions may include computer-executable code configured to perform various functions and/or enable various aspects described herein. The computer-executable code may be executed by various hardware components (e.g., the processor 104) of the master device 101. The instructions may be a part of various software programs and/or software modules.

The computer-readable medium 106 may include profile determination instructions 140. The profile determination instructions 140 may include computer-executable code configured for performing various functions and/or enable various aspects associated with the profile of the master device 101. As described above, the profile of the master device 101 may refer to the set of parameters and/or functions that characterize the operability and/or user experience of the master device 101. The profile of the master device 101 may include information related to the operating system of the master device 101, one or more peripheral components of the master device 101, a display size of one or more displays of the master device 101, a display resolution of one or more displays of the master device 101, a touch screen-capability of the master device 101, one or more font types of the master device 101, one or more user settings of the master device 101, an EDID of the master device 101, the power source/availability of the master device 101, one or more hardware components of the master device 101, and/or one or more software modules of the master device 101. Additional description pertaining to the profile of the master device 101 is provided throughout this disclosure. The profile determination instructions 140 may include computer-executable code configured for determining whether a profile of another device (e.g., the slave device 102) matches one of a plurality of profiles stored in the master device 101.

The computer-readable medium 106 may also include data exportation instructions 141. The data exportation instructions 141 may include computer-executable code configured for performing various functions and/or enable various aspects associated with exporting data from the master device 101. For example, the data may be exported to another device (e.g., the slave device 102). In some circumstances, the profile of the slave device 102 matches one of the plurality of profiles stored in the master device 101. In such circumstances, the data exportation instructions 141 may include computer-executable code configured for exporting data to the slave device 102 in a format associated with the profile of the slave device 102. However, in some other circumstances, the profile of the slave device 102 does not match one of the plurality of profiles stored in the master device 101. In such circumstances, the data exportation instructions 141 may include computer-executable code configured for exporting data to the slave device 102 in a format associated with a default profile of the master device 101.

The computer-readable medium 106 may also include notification instructions 142. The notification instructions 142 may include computer-executable code configured for performing various functions and/or enable various aspects associated with providing notifications to the master device 101 and/or the slave device 102. When the profile of the slave device 102 does not match one of the plurality of profiles stored in the master device 101, the notification instructions 142 may include computer executable code configured for providing an error message on the master device 101 and/or the slave device 102. For example, the error message may indicate that none of the profiles stored in the master device 101 match any of the profiles of the slave device 102.

In some circumstances, the slave device 102 is within a proximity range of the master device 101. The proximity range may be a particular distance relative to the location of the master device 101. In such circumstances, the notification instructions 142 include computer-executable code configured for providing a notification for display on the slave device 102. For example, such notifications may include various alerts, such as low-battery′ alerts. Because the slave device 102 is within the proximity range of the master device 101, notifications displayed on the slave device 102 are more likely to be viewed by the user.

In some other circumstances, the slave device 102 is beyond the proximity range of the master device 101. For example, the master device 101 (e.g., a smartphone) may be moved by the user out of a room having the slave device 102 (e.g., a desktop computer). When the slave device 102 is beyond the proximity range of the master device 101, the notification instructions 142 include computer-executable code configured for providing various notifications (e.g., alerts, such as low-battery′ alerts) for display on the master device 101. Because the user (together with the master device 101) has moved beyond the proximity range of the master device 101, notifications displayed on the slave device 102 are less likely to be viewed by the user, and notifications displayed on the master device 101 are more likely to be viewed by the user.

The computer-readable medium 106 may also include attribute adjustment instructions 143. The attribute adjustment instructions 143 include computer-executable code configured for performing various functions and/or enable various aspects associated with adjusting an attribute of the data for export to the slave device 102. In some configurations, the attributes of the data may be adjusted based on bandwidth availability. Accordingly, the attributes adjustment instructions 143 include computer-executable code configured for adjusting the attribute of the data for export to the slave device 102 based on bandwidth availability. Attributes that may be adjusted include a file size, a refresh rate, a display resolution, a bit rate, a quality parameter, and/or a domain. Such attributes may be adjusted such that the exported data occupies relatively less bandwidth when bandwidth availability is relatively low. Conversely, such attributes may be adjusted such that the exported data occupies relatively more bandwidth when bandwidth availability is relatively high.

The foregoing description provides a non-limiting example of the computer-readable medium 106 of the master device 101. Although various instructions (e.g., computer-executable code) have been described above, one of ordinary skill in the art will understand that the computer-readable medium 106 may also include various other instructions 144 that are in addition and/or alternative(s) to instructions 140, 141, 142, 143. Such other instructions 144 may include computer-executable code configured for performing any one or more of the functions, methods, processes, features and/or aspects described herein.

The memory 114 may include various memory modules. The memory modules may be configured to store, and have read therefrom, various values and/or information by the processor 104, or any of its circuits 120, 121, 122, 123, 124. The memory modules may also be configured to store, and have read therefrom, various values and/or information upon execution of the computer-executable code included in the computer-readable medium 106, or any of its instructions 140, 141, 142, 143, 144.

The memory 114 may include profile information 130. The profile information may include data pertaining to the set of parameters and/or functions that characterize the operability and/or user experience of the master device 101. The profile information 130 may also include data related to the operating system of the master device 101, one or more peripheral components of the master device 101, a display size of one or more displays of the master device 101, a display resolution of one or more displays of the master device 101, a touch screen-capability of the master device 101, one or more font types of the master device 101, one or more user settings of the master device 101, an EDID of the master device 101, the power source/availability of the master device 101, one or more hardware components of the master device 101, and/or one or more software modules of the master device 101.

The memory 114 may also include various types of data that may be exported to the slave device 102. A non-limiting example of such data is application data 131. The application data 131 may be generated by an application running in the master device 101. The application data 131 may be exported from the master device 101 to the slave device 102 in accordance to various configurations described herein. Although application data 131 is provided as a non-limiting example, one of ordinary skill in the art will understand that additional and/or alternative types of data may be stored in the memory and exported from the master device 101 to the slave device 102 without deviating from the scope of the present disclosure. One of ordinary skill in the art will also understand that the memory 114 may also include various other memory modules 132. The other memory modules 132 may be configured for storing information therein, and reading information therefrom, with respect to any of the features, functions, methods, processes, and/or aspects described herein.

One of ordinary skill in the art will also understand that the master device 101 may include alternative and/or additional elements without deviating from the scope of the present disclosure. In accordance with various aspects of the present disclosure, an element, or any portion of an element, or any combination of elements may be implemented with a processing system 101 that includes one or more processors 104. Examples of the one or more processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system 101 may be implemented with a bus architecture, represented generally by the bus 103 and bus interface 108. The bus 103 may include any number of interconnecting buses and bridges depending on the specific application of the processing system 101 and the overall design constraints. The bus 103 may link together various circuits including the one or more processors 104, the memory 114, and the computer-readable media 106. The bus 103 may also link various other circuits such as timing sources, peripherals, voltage regulators, and power management circuits, which are well known in the art.

The one or more processors 104 may be responsible for managing the bus 103 and general processing, including the execution of software stored on the computer-readable medium 106. The software, when executed by the one or more processors 104, causes the processing system 101 to perform the various functions described below for any one or more apparatuses. The computer-readable medium 106 may also be used for storing data that is manipulated by the one or more processors 104 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 106 may also include, by way of example, a carrier wave, a transmission line, and any other suitable medium for transmitting software and/or instructions that may be accessed and read by a computer. The computer-readable medium 106 may reside in the processing system 101, external to the processing system 101, or distributed across multiple entities including the processing system 101. The computer-readable medium 106 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

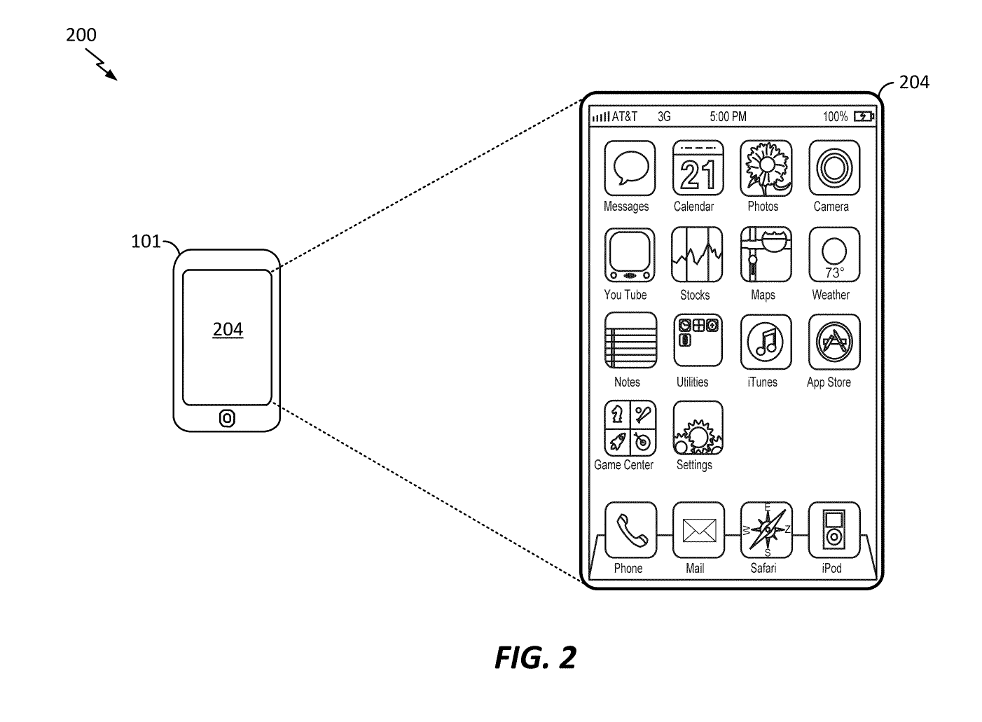

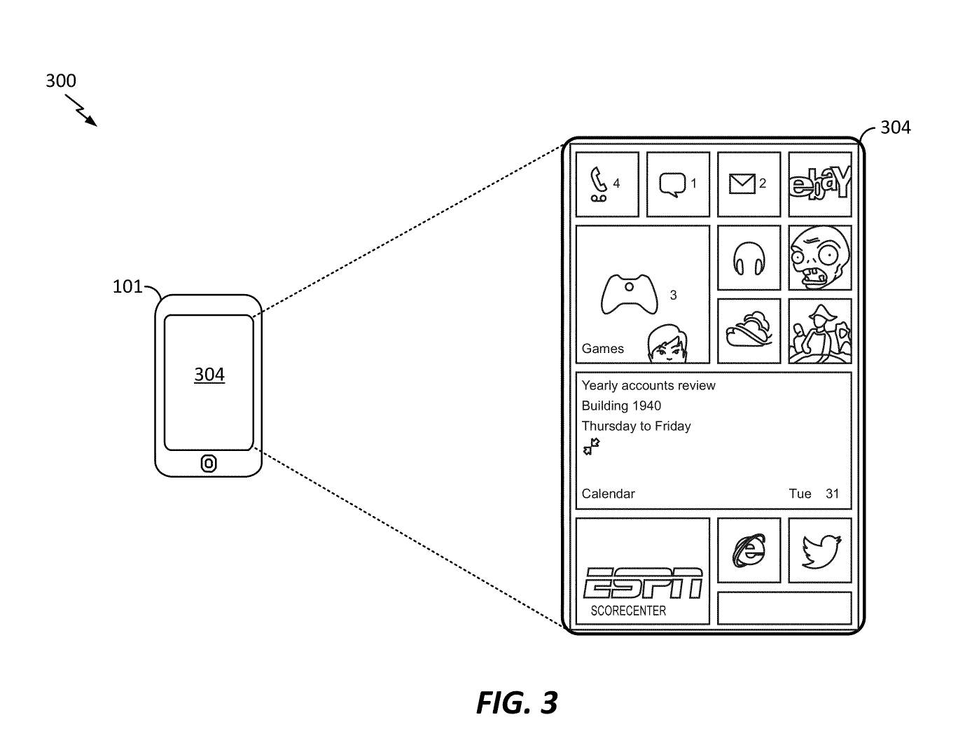

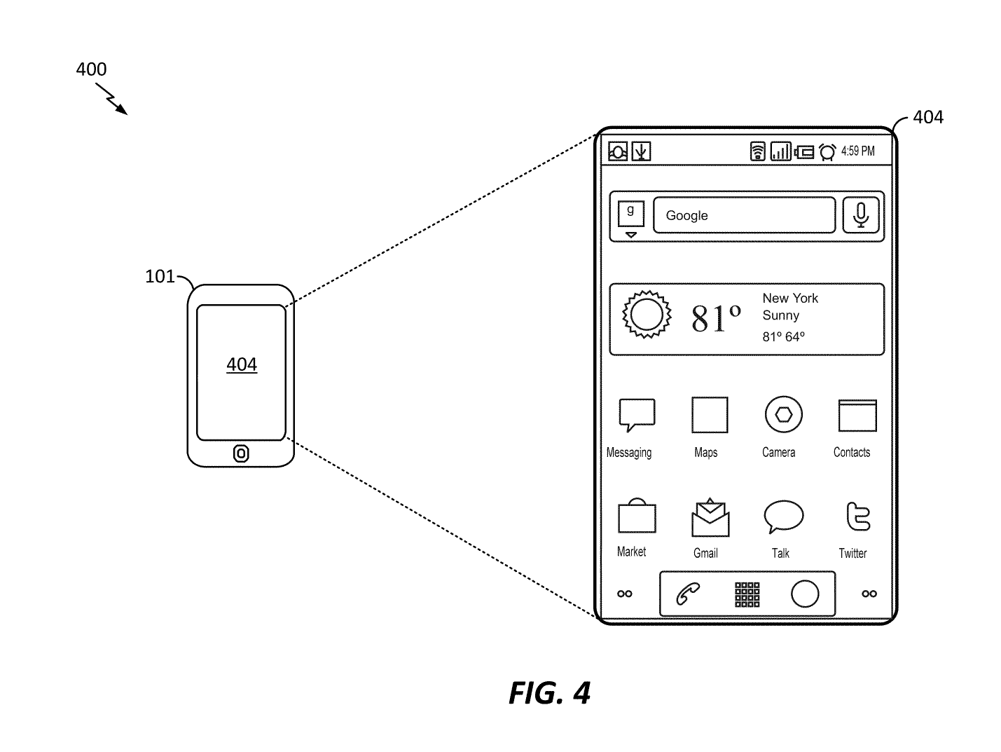

FIGS. 2-4 are diagrams 200, 300, 400 illustrating examples of user interfaces 204, 304, 404 of various profiles of the master device 101. The master device 101 may include one or more profiles. As described above, the profile may refer to the set of parameters and/or functions that characterize the operability and/or user experience of the master device 101. The profile of the master device 101 may include a particular operating system-based user experience. FIG. 2 illustrates an example of a user interface 204 of a profile that provides an iOS™ operating system-based user experience for the user of the master device 101. FIG. 3 illustrates an example of a user interface 304 of a profile that provides a Windows™ operating system-based user experience for the user of the master device 101. FIG. 4 illustrates an example of a user interface 404 of a profile that provides an Android™ operating system-based user experience for the user of the master device 101.

One of ordinary skill in the art will understand that FIGS. 2-4 illustrate non-limiting examples of various operating system-based user experiences that may be a part of the profile of the master device 101. One of ordinary skill in the art will also understand that the profile of the master device 101 does not necessarily need to include features associated with an operating system. As described above, the profile includes the parameters and/or functions that characterize the operability and/or user experience of the master device 101. Without deviating from the scope of the present disclosure, the profile of the master device 101 may include information related to one or more peripheral components of the master device 101, a display size of one or more displays of the master device 101, a display resolution of one or more displays of the master device 101, a touch screen-capability of the master device 101, one or more font types of the master device 101, one or more user settings of the master device 101, an EDID of the master device 101, the power source/availability of the master device 101, one or more hardware components of the master device 101, and/or one or more software modules of the master device 101.

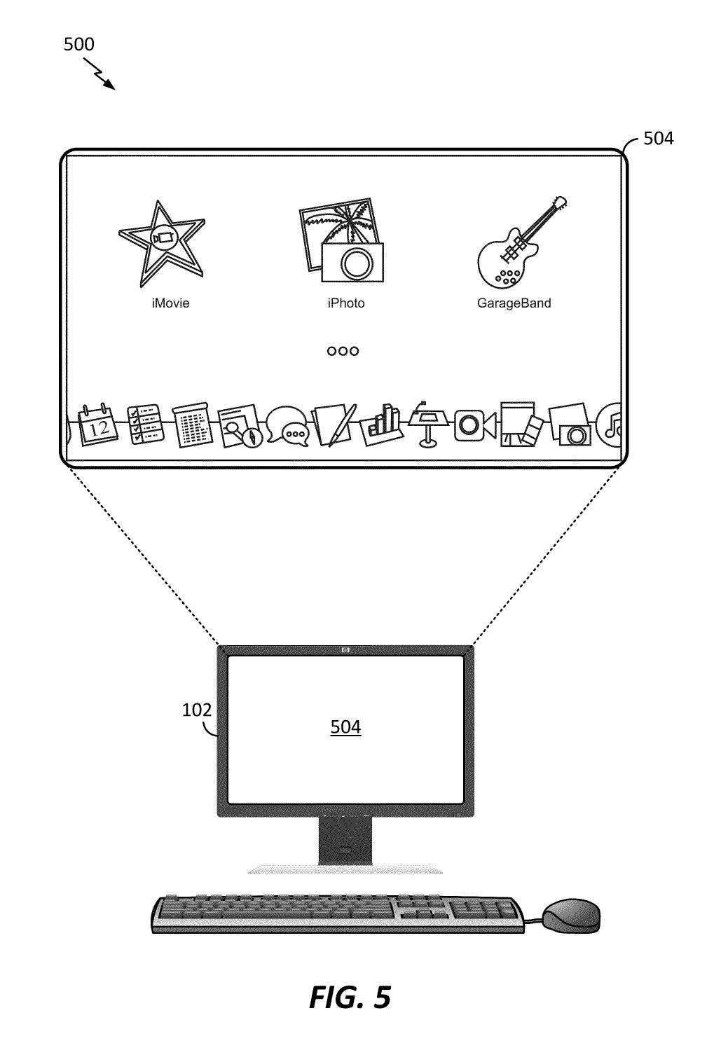

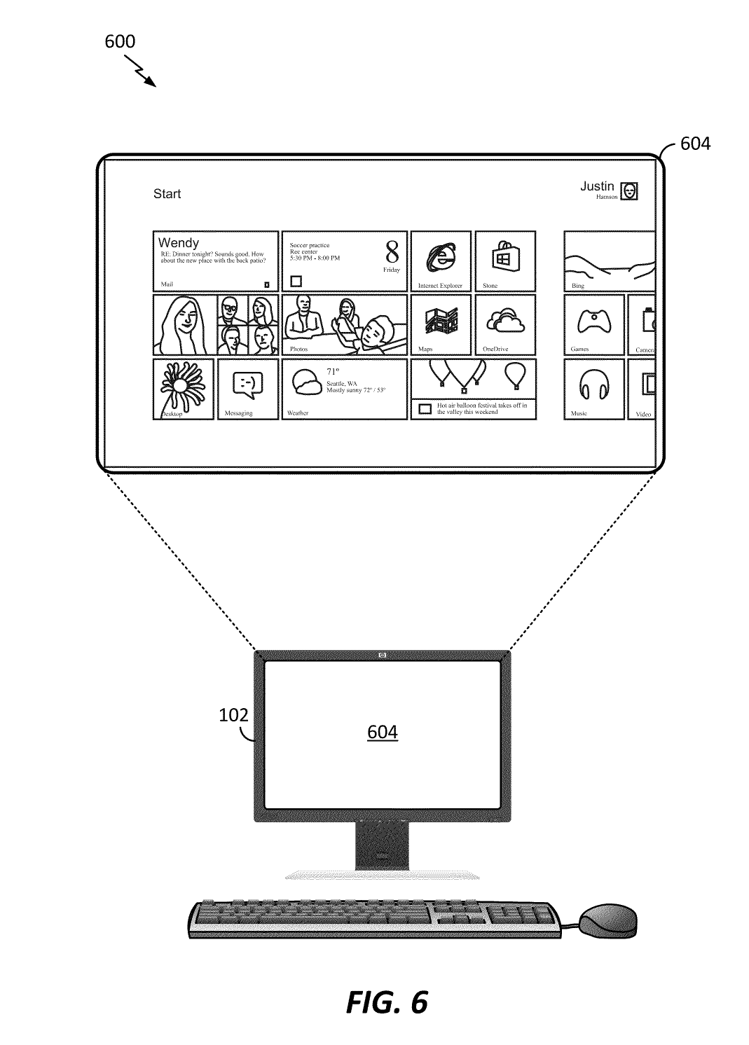

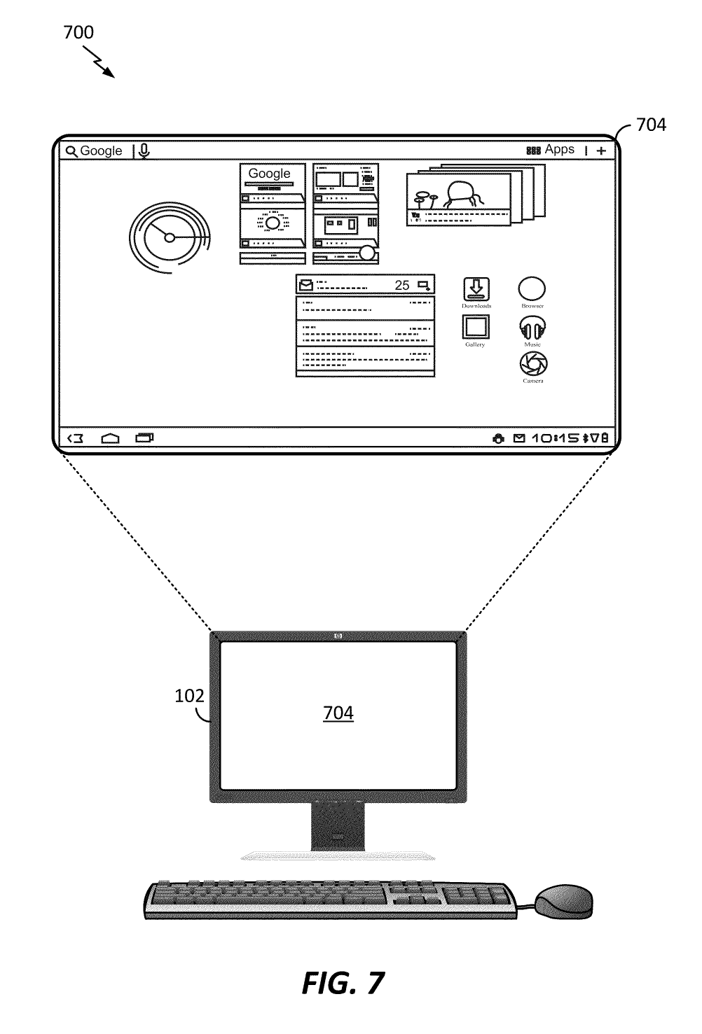

FIGS. 5-7 are diagrams 500, 600, 700 illustrating examples of user interfaces 504, 604, 704 of various profiles of the slave device 102. The slave device 102 may include one or more profiles. The profile includes the parameters and/or functions that characterize the operability and/or user experience of the slave device 102. The profile of the slave device 102 may include a particular operating system-based user experience. FIG. 5 illustrates an example of a user interface 504 of a profile that provides an iOS™ operating system-based user experience for the user of the slave device 102. FIG. 6 illustrates an example of a user interface 604 of a profile that provides a Windows™ operating system-based user experience for the user of the slave device 102. FIG. 7 illustrates an example of a user interface 704 of a profile that provides an Android™ operating system-based user experience for the user of the slave device 102.

One of ordinary skill in the art will understand that FIGS. 5-7 illustrate non-limiting examples of various operating system-based user experiences that may be a part of the profile of the slave device 102. One of ordinary skill in the art will also understand that the profile of the slave device 102 does not necessarily need to include features associated with an operating system. The profile includes the parameters and/or functions that characterize the operability and/or user experience of the slave device 102. Without deviating from the scope of the present disclosure, the profile of slave device 102 may include information related to one or more peripheral components of the slave device 102, a display size of one or more displays of the slave device 102, a display resolution of one or more displays of the slave device 102, a touch screen-capability of the slave device 102, one or more font types of the slave device 102, one or more user settings of the slave device 102, an EDID of the slave device 102, the power source/availability of the slave device 102, one or more hardware components of the slave device 102, and/or one or more software modules of the slave device 102.

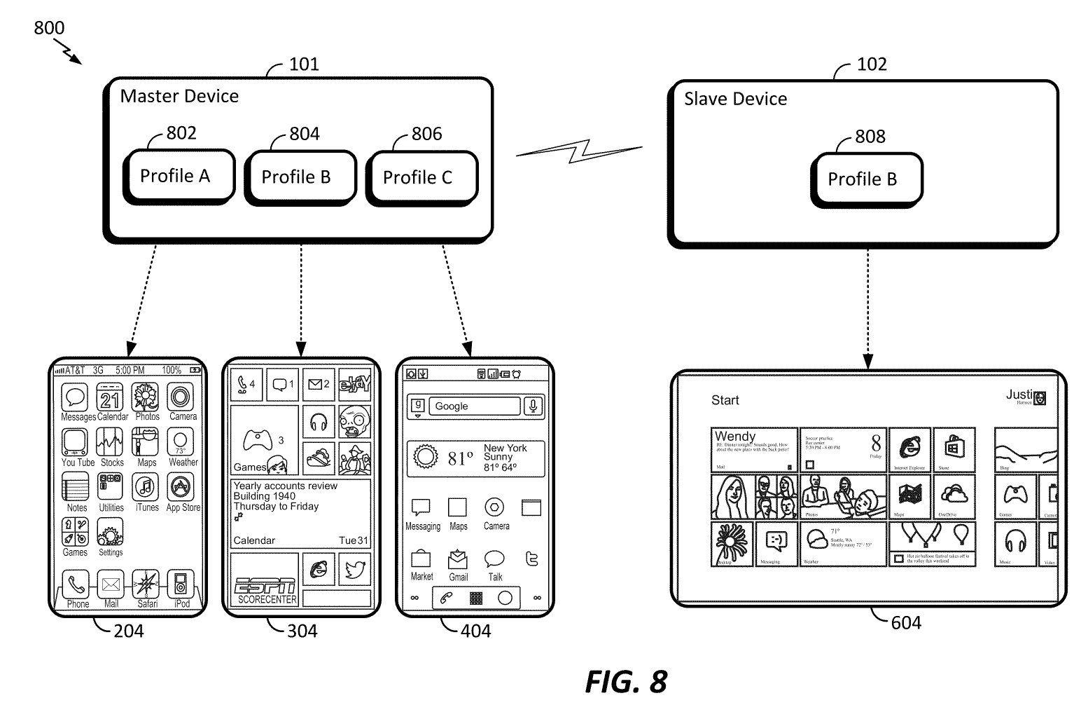

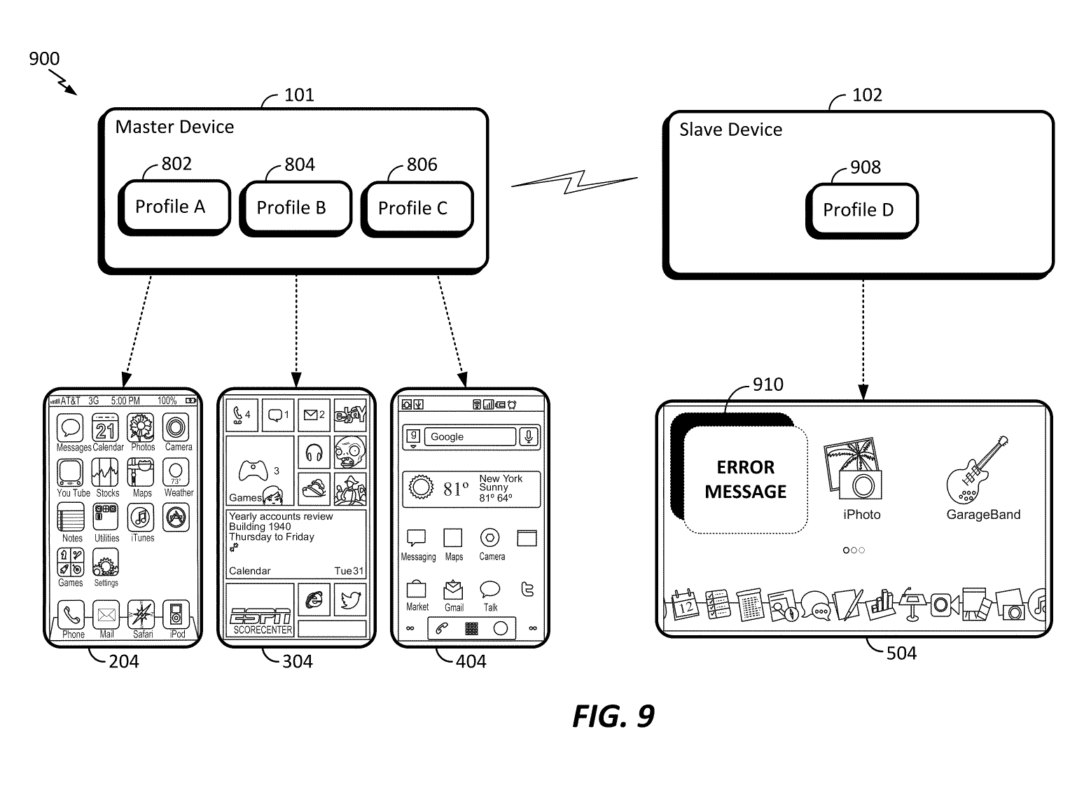

FIGS. 8-9 are diagrams 800, 900 illustrating examples of various profiles of the master device 101 and the slave device 102. In some configurations, the master device 101 and the slave device 102 may be connected wirelessly together via a wireless docking system. A wireless docking system may provide seamless connectivity, enabling two or more devices to connect together without needing wires, a docking connector, a personal identification number (PIN) code, elaborate pairing process per peripheral, or other similar steps. Peripherals associated with the slave device 102 may act as a group. Many different types of peripherals may be supported, including bridging of legacy peripherals. Existing application sessions/connections may be left intact.

To establish a wireless docking session, the master device 101 and the slave device 102 may receive and/or transmit various types of information. For example, the master device 102 may transmit a probe request to the slave device 102. In response to the probe request, the slave device 102 may transmit a response message. Such exchanges of information may allow the master device 101 to discover the slave device 102. The master device 101 and the slave device 102 may also engage in various authentication/association exchanges. The master device 101 and the slave device 102 may also engage in a handshake procedure as well as a channel establishment process. However, one of ordinary skill in the art will understand that every feature described in the above non-limiting example is not necessarily required and that alternative and/or additional steps may be implemented without deviating from the scope of the present disclosure. After establishing a wireless docking session with the slave device 102, the master device 101 may determine the profile of the slave device 102 and compare the profile of the slave device 102 with a look-up table stored in the master device 101 (e.g., a look-up table stored in the profile information 130). Such a comparison may reveal whether the profile of the slave device 102 matches any of the profiles stored in the master device 101.

More specifically, FIG. 8 is a diagram 800 illustrating an example wherein at least one of the profiles stored in the master device 101 matches a profile of the slave device 102. Matching may existing when at least one of the parameters and/or functions that characterize the operability and/or user experience of a first device (e.g., the master device 101) is the same as or similar to at least one of the parameters and/or functions that characterize the operability and/or user experience of a second device (e.g., the slave device 102). For purposes of illustration, the example provided in FIG. 8 depicts three profiles (e.g., Profile A 802, Profile B 804, Profile C 806). However, one of ordinary skill in the art will appreciate that a fewer or greater number of profiles may be stored in the master device 101 without deviating from the scope of the present disclosure.

By way of example and not limitation, Profile A 802 of the master device 101 may include the parameters and/or functions that characterize an iOS™ operating system-based user experience. Accordingly, the master device 101 may be capable of providing the user interface 204. Profile B 804 of the master device 101 may include the parameters and/or functions that characterize a Windows™ operating system-based user experience. Accordingly, the master device 101 may be capable of providing the user interface 304. Profile C 806 of the master device 101 may include the parameters and/or functions that characterize an Android™ operating system-based user experience. Accordingly, the master device 101 may be capable of providing the user interface 404.

The slave device 102 has Profile B 808, which matches at least one of the profiles (e.g., Profile B 804) stored in the master device 101. When the profile of the slave device 102 matches (at least) one of the profiles stored in the master device 101, the master device 101 may export data to the slave device 102 (e.g., during the wireless docking session) in a format associated with the profile of the slave device 102. Exporting may be performed via wireless transmission over one of various wireless communication interfaces (e.g., a WLAN interface and/or a Bluetooth™ interface). Exporting may also include an encryption process, wherein the data to be exported is encrypted prior to wireless transmission from the master device 101 to the slave device 102. A format of the data may refer to the configuration and/or formatting of the data. Data may be successfully processed by the slave device 102 when the data is formatted in a manner that enables that the slave device 102 to process the data by its processing system. If the data is not formatted in such a manner, the data may be incompatible with the slave device 102.

As described above, Profile B 804, 808 includes the parameters and/or functions that characterize a Windows™ operating system-based user experience. The master device 101 may export data to the slave device 102 (e.g., during the wireless docking session) in a format that provides a Windows™ operating system-based user experience. As such, the slave device 102 provides a visualization that corresponds to a Windows™ operating system. Accordingly, the slave device 102 displays the user interface 604.

In contrast to FIG. 8, FIG. 9 is a diagram illustrating an example wherein none of the profiles stored in the master device 101 matches the profile of the slave device 102. As illustrated in FIG. 9, the slave device 102 has Profile D 908. Profile D 908 is not included as any of the profiles (e.g., Profile A 802, Profile B 804, Profile C 806) stored in the master device 101. When the profile of the slave device 102 does not match any of the profiles stored in the master device 101, in some configurations, the master device 201 may provide an error message 910. The error message 910 may be a visual message provided for display on a display component of the master device 101 and/or a display component of the slave device 102. For example, as illustrated in FIG. 9, the error message 910 may appear on a portion of the user interface 504 of the slave device 201. An error message may, alternatively or additionally, be an auditory message provided for playing on the master device 101 and/or the slave device 102. Alternative forms of providing an error message may be implemented without deviating from the scope of the present disclosure.

In some configurations, when the profile of the slave device 102 does not match any of the profiles stored in the master device 101, the master device 101 may export data to the slave device 102 in a format associated with a default profile of the master device 101. A default profile of the master device 101 may be a profile that is preferred by the user. For instance, the user may set Profile A 802 as the default profile because the user prefers the user interface of that profile over the user interface of other profiles. Alternatively, a default profile of the master device 101 may be a profile that is set by the manufacturer of the master device. For instance, the manufacturer may set Profile A 802 as the default profile because the master device 101 is configured to operate more efficiently using that profile relative to other profiles. Because the profile of the slave device 102 (e.g., Profile D 908) does not match any of the profiles (e.g., Profile A 802, Profile B 804, Profile C 806) stored in the master device 101, the master device 101 may export data to the slave device 102 (e.g., during the wireless docking session) in the format of the default profile of the master device 101 (e.g., Profile A 802). Because Profile A 802 includes the parameters and/or functions that characterize an iOS™ operating system-based user experience, the master device 101 may export data to the slave device 102 (e.g., during the wireless docking session) in a format that provides an iOS™ operating system-based user experience. As such, the slave device 102 provides a visualization that corresponds to an iOS™ operating system. Accordingly, the slave device 101 displays the user interface 504.

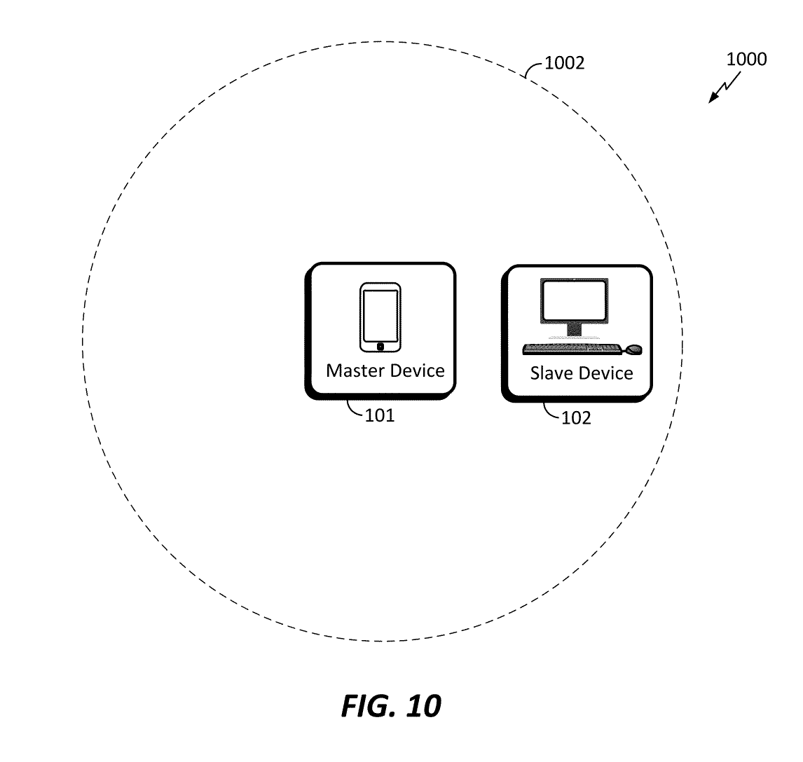

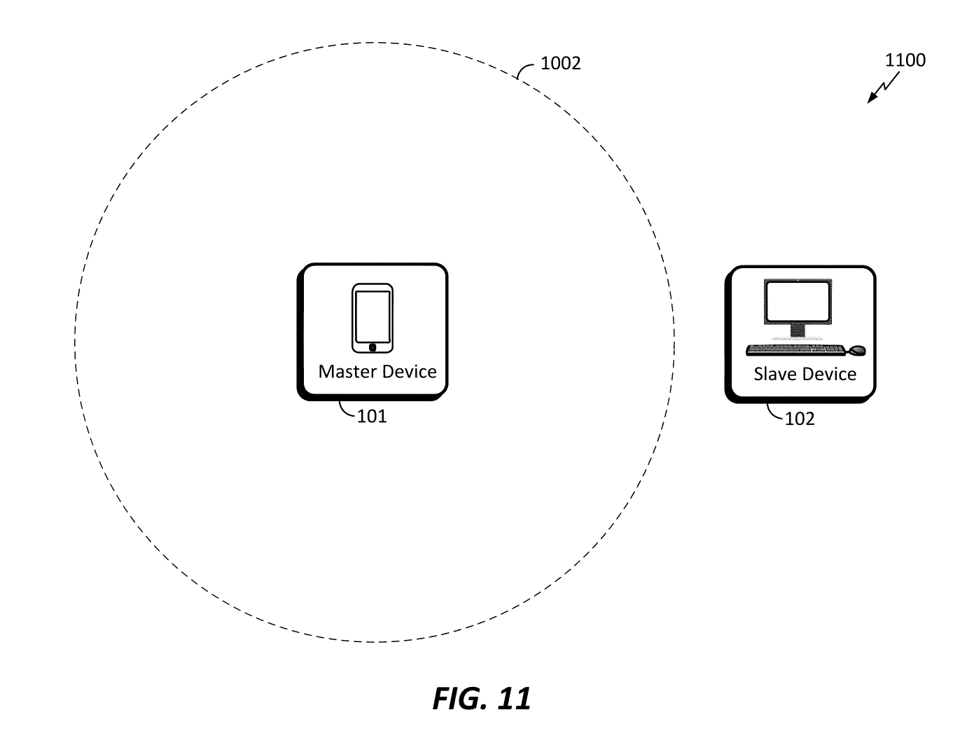

FIGS. 10-11 are diagrams 1000, 1100 illustrating examples of proximities of the slave device 102 relative to the master device 101. The master device 101 may have a proximity range 1002. For example, the proximity range may be a distance (e.g., measured in units of feet or meters). In some configurations, the proximity range 1002 may be preselected by the user of the slave device 102. In some configurations, the proximity range 1002 may be preset by the manufacturer of the master device 101. Various techniques may be used to determine the proximity range 1002. For example, the proximity range 1002 may be determined using the received signal strength of a signal (e.g., a pilot signal) from another device (e.g., the slave device 102). As another example, the proximity range 1002 may be determined using calculations of ‘round-trip time’ of a signal originating from the master device 101. Additional or alternative techniques for determining the proximity range 1002 are known to one of ordinary skill in the art and may be used without deviating from the scope of the present disclosure. Given the capability of the master device 101 and the slave device 102 to communicate wirelessly with each other, these devices may be moved closer/farther apart relative to each other during normal use.

More specifically, FIG. 10 is a diagram 1000 illustrating an example wherein the slave device 102 is within the proximity range 1002 of the master device 101. For example, the master device 101 (e.g., a smartphone) may be moved by the user into a room having the slave device (e.g., a desktop computer). When the slave device 102 is within the proximity range 1002 of the master device 101, the master device 101 may provide various notifications (e.g., alerts, such as low-battery′ alerts) for display on the slave device 102. Because the slave device 102 is within the proximity range 1002 of the master device 101, notifications displayed on the slave device 102 are more likely to be viewed by the user.

More specifically, FIG. 11 is a diagram 1100 illustrating an example wherein the slave device 102 is beyond the proximity range 1002 of the master device 101. For example, the master device 101 (e.g., the smartphone) may be moved by the user out of the room having the slave device 102 (e.g., the desktop computer). When the slave device 102 is beyond the proximity range 1002 of the master device 101, the master device 101 may provide various notifications (e.g., alerts, such as low-battery′ alerts) for display on the master device 101. Because the user has moved (together with the master device 101) beyond the proximity range 1002 of the master device 101, notifications displayed on the slave device 102 are less likely to be viewed by the user, and notifications displayed on the master device 101 are more likely to be viewed by the user.

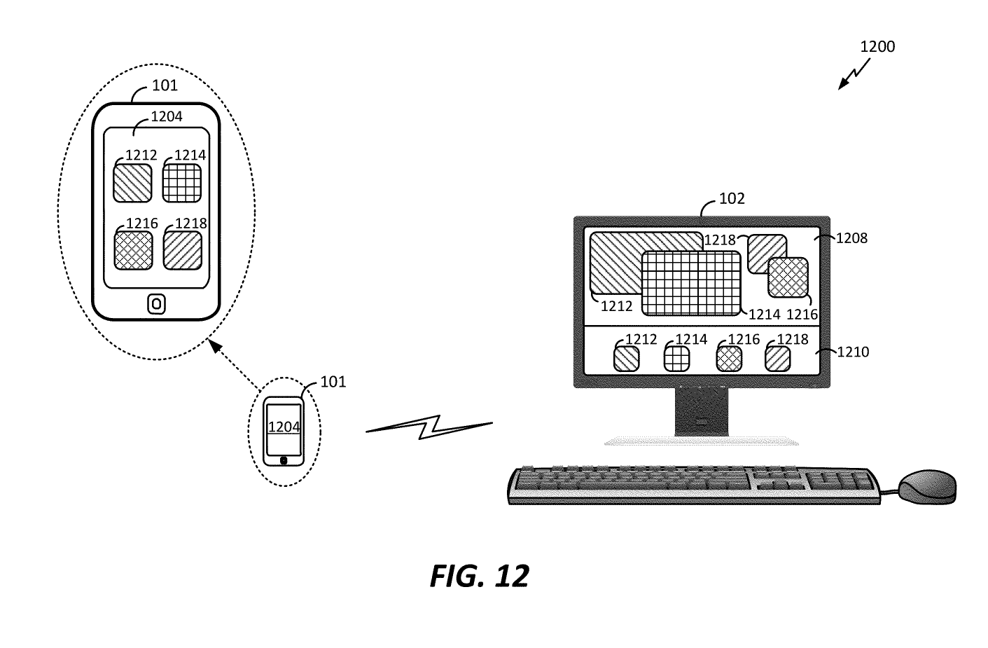

FIG. 12 is a diagram 1200 illustrating an example of various items displayed on the master device 101 and the slave device 102. By way of example and not limitation, FIG. 12 illustrates a smartphone as the master device 101 and a desktop computer as the slave device 102. However, one of ordinary skill in the art will understand that various other apparatuses (described above) may be used as the master device 101 and/or the slave device 201 without deviating from the scope of the present disclosure. The master device 101 may include a display 1204 (e.g., the user interface 112) configured for displaying various information to the user. In some configurations, the display 1204 may display one or more icons corresponding to various applications. One or more applications may be running at the same time. One or more of the launched applications may be running in the foreground. One or more of the launched applications may be running in the background. For the sake of simplicity and illustration, four applications (e.g., applications 1212, 1214, 1216, 1218) are illustrated in FIG. 12. However one of ordinary skill in the art will understand that a fewer or greater number of applications may be running (in the foreground and/or in the background) without deviating from the scope of the present disclosure. For purposes of this example, it will be assumed that applications 1212, 1214 are running in the foreground and that applications 1216, 1218 are running in the background. It will further be assumed that the profile of the slave device 102 is included in the plurality of profiles stored in the master device 101. As such, the master device 101 (e.g., the smartphone) is able to export data to the slave device 102 (e.g., the desktop computer) in a format associated with the profile of the slave device 102 (e.g., the desktop computer's Windows™ operating system).

In some configurations, an indication (e.g., an icon) for every launched application (e.g., applications 1212, 1214, 1216, 1218) is displayed in a task bar 1210 of the slave device 102. In some configurations, one or more applications running in the foreground (e.g., applications 1212, 1214) are displayed differently on a display 1208 of the slave device 102 relative to the applications running in the background (e.g., applications 1216, 1218). For example, an application running in the foreground (e.g., applications 1212, 1214) occupies a larger region of the display 1208 of the slave device 102 relative to an application running in the background (e.g., applications 1216, 1218).

In some configurations, the master device 101 may adjust one or more attributes of the data for export to the slave device 102 based on bandwidth availability. By way of example and not limitation, an attribute may include a file size, a refresh rate, a display resolution, a bit rate, a quality parameter, and/or a domain. Alternative attributes of data are readily apparent to one of ordinary skill in the art and may adjusted based on bandwidth availability without deviating from the scope of the present disclosure. As an example, the master device 101 may increase the resolution of an item displayed on the slave device 102 when bandwidth availability is high, and the master device 101 may decrease the resolution of the item displayed on the slave device 102 when bandwidth availability is low. As another example, the master device 101 may increase the refresh rate of an item displayed on the slave device 102 when bandwidth availability is high, and the master device 101 may decrease the refresh rate of the item displayed on the slave device 102 when bandwidth availability is low.

In some configurations, two different types of applications may be transmitted across different domain types. For example, a productivity-type application (e.g., a word processing application or spreadsheet application) may be transmitted over a graphics domain, and other types of applications may be transmitted over a pixel domain.

In some configurations, the master device 101 may turn off the display 1204 of the master device 101 after exporting the data to the slave device 102. By turning off the display 1204 of the master device 101, the master device 101 may conserve power. However, turning off the display 1204 of the master device 101 is not a requirement. In some other configurations, the master device 101 may keep the display 1204 of the master device 101 turned on and use that display 1204 as an extended display of the slave device 102.

In some configurations, the slave device 102 may display a website differently than the display of that website on the master device 101. For example, the master device 101 may display the website according to a first a uniform resource locator (URL) (e.g., a URL configured for display on a mobile device, such as “m.exampleURL.com”), and the slave device may display the website according to a second URL (e.g., a URL configured for display on a non-mobile device, such as “exampleURL.com”). Because the screen size and/or display resolution of the master device 101 may not be the same as the screen size and/or display resolution of the slave device 102, the user experience may be enhanced by presenting websites according to URLs that are optimized for the screen size and/or display resolution of the particular device.

In some configurations, the master device 101 may export the data in a format that complies with a government regulation. By way of example and not limitation, the slave device 102 may be a device inside of an automobile. The master device 101 may export data to the slave device 102 in a format that complies with automotive safety standards. Some automotive safety standards may require speech-to-text and/or text-to-speech capabilities for such devices. Accordingly, the master device 101 may export data to the slave device 102 in a format that accommodates for the speech-to-text and/or text-to-speech capabilities of the slave device 102.

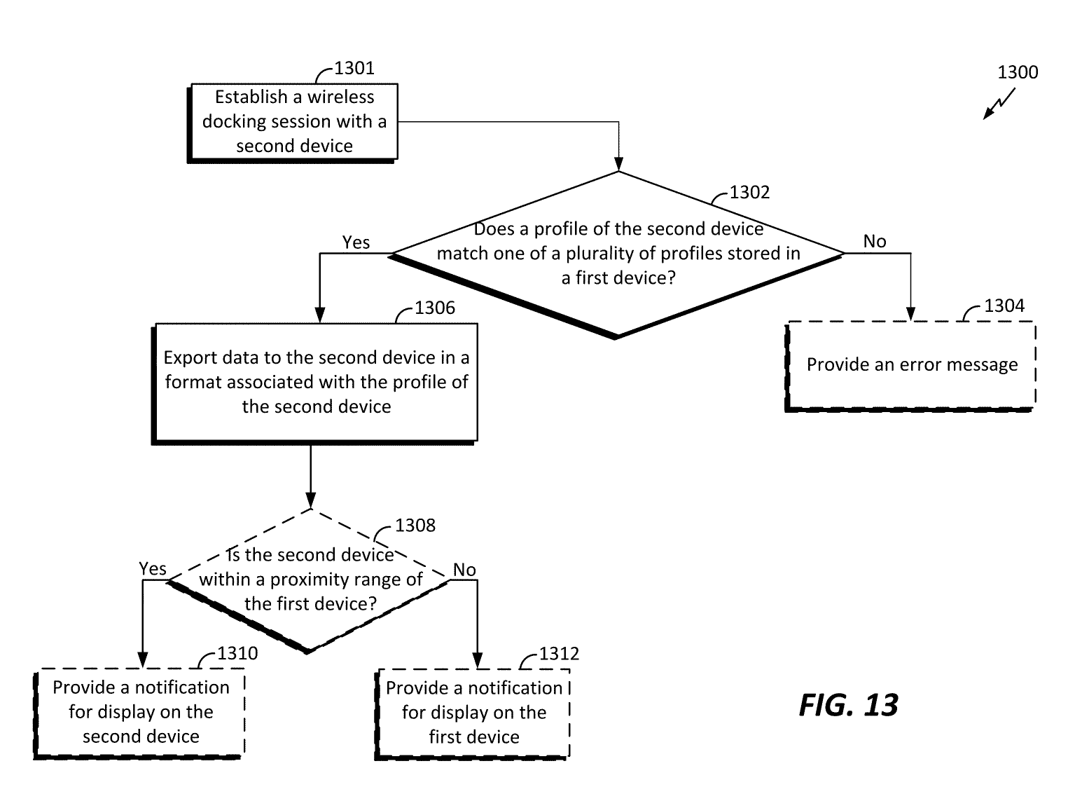

FIG. 13 is a first diagram 1300 illustrating an example of various methods and/or processes. The methods and/or processes described with reference to FIG. 13 may be performed by any device. As a non-limiting example, the first device may be the master device 101, as described in greater detail above. At block 1301, the first device may establish a wireless docking session with a second device (e.g., slave device 102). At block 1302, the first device may determine whether a profile of the second device matches one a plurality of profiles stored in the first device. As a non-limiting example, the second device may be the slave device 102, as described in greater detail above.

When the second device does not match one of the plurality of profiles store in the first device, at block 1304, the first device provides an error message. For example, referring to FIG. 9, the slave device 102 has Profile D 908. Profile D 908 is not included as any one of the profiles (e.g., Profile A 802, Profile B 804, Profile C 806) stored in the master device 101. When the profile of the slave device 102 does not match any of the profiles stored in the master device 101, the master device 201 may provide an error message 910. The error message 910 may be a visual message provided for display on a display component of the master device 101 and/or a display component of the slave device 102. Alternatively or additionally, an error message may be an auditory message provided for playing on the master device 101 and/or the slave device 102. Other forms of providing an error message may be used without deviating from the scope of the present disclosure.

When the second device does match one of the plurality of profiles store in the first device, at block 1306, the first device may export data to the second device in a format associated with the profile of the second device. For example, referring to FIG. 8, the slave device 102 has Profile B 808. The master device 101 includes Profile B 804. Accordingly, a profile (e.g., Profile B 808) of the slave device 102 matches one of the profiles (e.g., Profile B 804) stored in the master device 101. As such, the master device 101 may export data to the slave device 102 (e.g., during the wireless docking session) in a format associated with the profile of the slave device 102. For example, assuming that Profile B 804, 808 indicates a Windows™ operating system, the master device 101 may export data to the slave device 102 (e.g., during the wireless docking session) in a format that provides a Windows™ operating system-based user experience. Accordingly, the slave device 102 provides a visualization that corresponds to a Windows™ operating system (i.e., user interface 604).

In some configurations, at block 1308, the first device may determine whether the second device is within a proximity range of the first device. For example, referring to FIG. 10, the master device 101 may determine whether the slave device 102 is within the proximity range 1002 of the master device 101. For example, the proximity range may be a distance (e.g., measured in units of feet or meters). In some configurations, the proximity range 1002 may be preselected by the user of the slave device 102. In some configurations, the proximity range 1002 may be preset by the manufacturer of the master device 101. Various techniques may be used to determine the proximity range 1002, as described in greater detail above.

When the second device is within a proximity range of the first device, at block 1310, the first device may provide a notification for display on the second device. For example, referring to FIG. 10, the master device 101 (e.g., a smartphone) may be moved by the user into a room having the slave device 102 (e.g., a desktop computer). When the slave device 102 is within the proximity range 1002 of the master device 101, the master device 101 may provide various notifications (e.g., alerts, such as low-battery′ alerts) for display on the slave device 102. Because the slave device 102 is within the proximity range 1002 of the master device 101, notifications displayed on the slave device 102 are more likely to be viewed by the user.

When the second device is beyond the proximity range of the first device, at block 1312, the first device may provide the notification for display on the first device. For example, referring to FIG. 11, the slave device 102 is beyond the proximity range 1002 of the master device 101. For example, the master device 101 (e.g., the smartphone) may be moved by the user out of the room having the slave device 102 (e.g., the desktop computer). When the slave device 102 is beyond the proximity range 1002 of the master device 101, the master device 101 may provide various notifications (e.g., alerts, such as low-battery′ alerts) for display on the master device 101. Because the user has moved (together with the master device 101) beyond the proximity range 1002 of the master device, notifications displayed on the slave device 102 are less likely to be viewed by the user, and notifications displayed on the master device 101 are more likely to be viewed by the user.

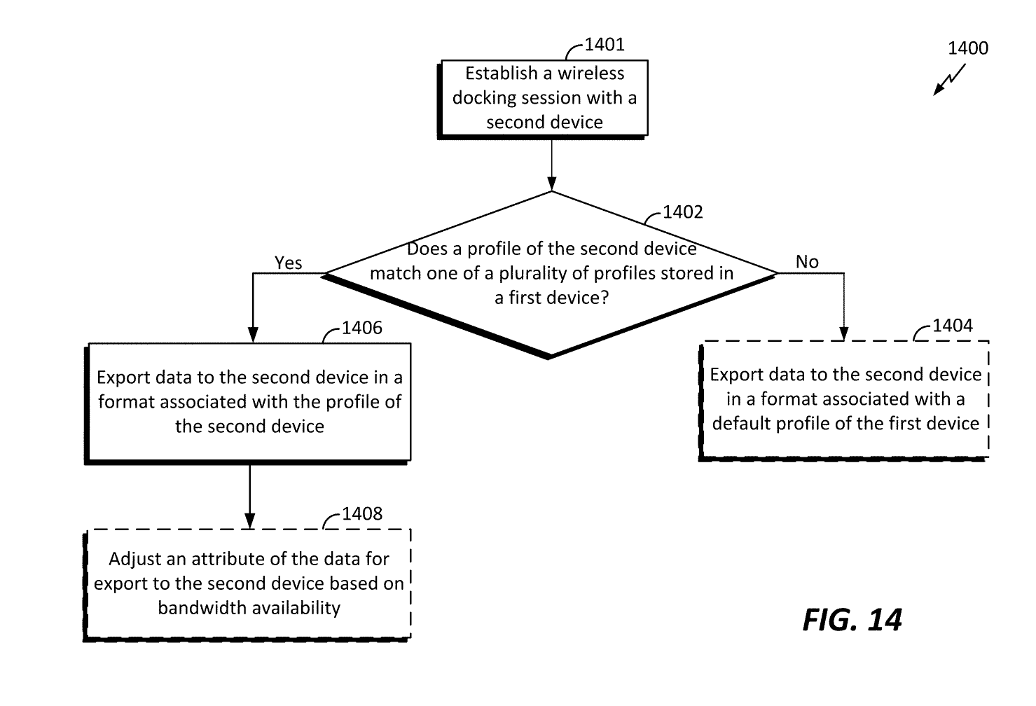

FIG. 14 is a second diagram 1400 illustrating an example of various methods and/or processes. The methods and/or processes described with reference to FIG. 14 may be performed by any device. As a non-limiting example, the first device may be the master device 101, as described in greater detail above. At block 1401, the first device may establish a wireless docking session with a second device (e.g., slave device 102). At block 1402, the first device may determine whether a profile of the second device matches one a plurality of profiles stored in the first device. As a non-limiting example, the second device may be the slave device 102, as described in greater detail above.

When the second device does not match one of the plurality of profiles store in the first device, at block 1404, the first device may export data to the second device in a format associated with a default profile of the first device. For example, referring to FIG. 9, the master device 101 may export data to the slave device 102 in a format associated with the default profile of the master device 101. For example, in FIG. 9, the default profile for the master device 101 is Profile A 802. Because the profile of the slave device 102 (e.g., Profile D 908) does not match any of the profiles (e.g., Profile A 802, Profile 804, Profile 806) stored in the master device 101, the master device 101 may export data to the slave device 102 (e.g., during the wireless docking session) in the format of the default profile of the master device 101 (e.g., Profile A 802). Because Profile A 802 includes the parameters and/or functions that characterize an iOS™ operating system-based user experience, the master device 101 may export data to the slave device 102 (e.g., during the wireless docking session) in a format that provides an iOS™ operating system-based user experience. Accordingly, the slave device 102 provides a visualization corresponding to an iOS™ operating system (i.e., user interface 504).

When the second device does match one of the plurality of profiles store in the first device, at block 1406, the first device may export data to the second device in a format associated with the profile of the second device. For example, referring to FIG. 8, the slave device 102 has Profile B 808. The master device 101 includes Profile B 804. Accordingly, a profile (e.g., Profile B 808) of the slave device 102 matches one of the profiles (e.g., Profile B 804) stored in the master device 101. As such, the master device 101 may export data to the slave device 102 (e.g., during the wireless docking session) in a format associated with the profile of the slave device 102. For example, assuming that Profile B 804, 808 indicates a Windows™ operating system, the master device 101 may export data to the slave device 102 (e.g., during the wireless docking session) in a format that provides a Windows™ operating system-based user experience. Accordingly, the slave device 102 provides a visualization that corresponds to a Windows™ operating system (i.e., user interface 604).

At block 1408, the first device may adjust an attribute of the data for export to the second device based on bandwidth availability. As non-limiting examples, an attribute may include a file size, a refresh rate, a display resolution, a bit rate, a quality parameter, and/or a domain. Alternative attributes of data are readily apparent to one of ordinary skill in the art and may adjusted based on bandwidth availability without deviating from the scope of the present disclosure. In some configurations, the master device 101 may increase the resolution of an item displayed on the slave device 102 when bandwidth availability is high, and the master device 101 may decrease the resolution of the item displayed on the slave device 102 when bandwidth availability is low. In some configurations, the master device 101 may increase the refresh rate of an item displayed on the slave device 102 when bandwidth availability is high, and the master device 101 may decrease the refresh rate of the item displayed on the slave device 102 when bandwidth availability is low.

The methods and/or processes described with reference to FIGS. 13-14 are provided for illustrative purposes and are not intended to limit the scope of the present disclosure. The methods and/or processes described with reference to FIGS. 13-14 may be performed in sequences different from those illustrated therein without deviating from the scope of the present disclosure. Additionally, some or all of the methods and/or processes described with reference to FIGS. 13-14 may be performed individually and/or together without deviating from the scope of the present disclosure.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method performed by a first device, the method comprising:
establishing a wireless docking session with a second device;
determining whether a profile of the second device matches one of a plurality of profiles stored in the first device; and
exporting data to the second device in a format associated with the profile of the second device when the profile of the second device matches one of the plurality of profiles stored in the first device.

2. The method of claim 1, further comprising:
providing an error message when the profile of the second device does not match one of the plurality of profiles stored in the first device.

3. The method of claim 1, further comprising:
exporting data to the second device in a format associated with a default profile of the first device when the profile of the second device does not match one of the plurality of profiles stored in the first device.

4. The method of claim 1, further comprising:
providing a notification for display on the second device when the second device is within a proximity range of the first device; and
providing the notification for display on the first device when the second device is beyond the proximity range of the first device.

5. The method of claim 1, further comprising:
adjusting an attribute of the data for export to the second device based on bandwidth availability.

6. The method of claim 5, wherein the attribute comprises at least one of a file size, a refresh rate, a display resolution, a bit rate, a quality parameter, or a domain.

7. The method of claim 1, wherein the data comprises:
first data associated with a foreground application and configured for display on a first region of the second device; and
second data associated with a background application and configured for display on a second region of the second device,
wherein the first region is larger than the second region.

8. The method of claim 1, wherein the profile comprises at least one of an operating system, a peripheral component, a display size, a display resolution, a touch screen-capability, a font type, a user setting, a hardware component, or a software module.

9. An apparatus for wireless communication, the apparatus comprising:
a transceiver;
a memory; and
at least one processor communicatively coupled to the transceiver and the memory and configured to:
establish a wireless docking session with a device;
determine whether a profile of the device matches one of a plurality of profiles stored in the apparatus; and
export data to the device in a format associated with the profile of the device when the profile of the device matches one of the plurality of profiles stored in the apparatus.

10. The apparatus of claim 9, wherein the at least one processor is further configured to:
provide an error message when the profile of the device does not match one of the plurality of profiles stored in the apparatus.

11. The apparatus of claim 9, wherein the at least one processor is further configured to:
export data to the device in a format associated with a default profile of the apparatus when the profile of the device does not match one of the plurality of profiles stored in the apparatus.

12. The apparatus of claim 9, wherein the at least one processor is further configured to:
provide a notification for display on the device when the device is within a proximity range of the apparatus; and
provide the notification for display on the apparatus when the device is beyond the proximity range of the apparatus.

13. The apparatus of claim 9, wherein the at least one processor is further configured to:
adjust an attribute of the data for export to the device based on bandwidth availability.

14. The apparatus of claim 13, wherein the attribute comprises at least one of a file size, a refresh rate, a display resolution, a bit rate, a quality parameter, or a domain.

15. The apparatus of claim 9, wherein the data comprises:
first data associated with a foreground application and configured for display on a first region of the device; and
second data associated with a background application and configured for display on a second region of the device,
wherein the first region is larger than the second region.

16. The apparatus of claim 9, wherein the profile comprises at least one of an operating system, a peripheral component, a display size, a display resolution, a touch screen-capability, a font type, a user setting, a hardware component, or a software module.

17. An apparatus for wireless communication, the apparatus comprising:
means for establishing a wireless docking session with a device;
means for determining whether a profile of the device matches one of a plurality of profiles stored in the apparatus; and
means for exporting data to the device in a format associated with the profile of the device when the profile of the device matches one of the plurality of profiles stored in the apparatus.

18. The apparatus of claim 17, further comprising:
means for providing an error message when the profile of the device does not match one of the plurality of profiles stored in the apparatus.

19. The apparatus of claim 17, further comprising:
means for exporting data to the device in a format associated with a default profile of the apparatus when the profile of the device does not match one of the plurality of profiles stored in the apparatus.

20. The apparatus of claim 17, further comprising:
means for providing a notification for display on the device when the device is within a proximity range of the apparatus; and
means for providing the notification for display on the apparatus when the device is beyond the proximity range of the apparatus.

21. The apparatus of claim 17, further comprising:
means for adjusting an attribute of the data for export to the device based on bandwidth availability.

22. The apparatus of claim 21, wherein the attribute comprises at least one of a file size, a refresh rate, a display resolution, a bit rate, a quality parameter, or a domain.

23. The apparatus of claim 17, wherein the data comprises:
first data associated with a foreground application and configured for display on a first region of the device; and
second data associated with a background application and configured for display on a second region of the device,
wherein the first region is larger than the second region.

24. The apparatus of claim 17, wherein the profile comprises at least one of an operating system, a peripheral component, a display size, a display resolution, a touch screen-capability, a font type, a user setting, a hardware component, or a software module.

25. A computer-readable medium of a first device, the computer-readable medium comprising computer-executable code configured for:
establishing a wireless docking session with a second device;
determining whether a profile of the second device matches one of a plurality of profiles stored in the first device; and
exporting data to the second device in a format associated with the profile of the second device when the profile of the second device matches one of the plurality of profiles stored in the first device.

26. The computer-readable medium of claim 25, wherein the computer-executable code is further configured for:
providing an error message when the profile of the second device does not match one of the plurality of profiles stored in the first device.

27. The computer-readable medium of claim 25, wherein the computer-executable code is further configured for:
exporting data to the second device in a format associated with a default profile of the first device when the profile of the second device does not match one of the plurality of profiles stored in the first device.

28. The computer-readable medium of claim 25, wherein the computer-executable code is further configured for:
providing a notification for display on the second device when the second device is within a proximity range of the first device; and
providing the notification for display on the first device when the second device is beyond the proximity range of the first device.

29. The computer-readable medium of claim 25, wherein the computer-executable code is further configured for:
adjusting an attribute of the data for export to the second device based on bandwidth availability.

30. The computer-readable medium of claim 25, wherein the data comprises:
first data associated with a foreground application and configured for display on a first region of the second device; and
second data associated with a background application and configured for display on a second region of the second device,
wherein the first region is larger than the second region.
